(19) United States
(12) Patent Application Publication
(10) Pub. No.: US 2020/0399931 A1
(43) Pub. Date: Dec. 24, 2020

(54) LOCK

(71) Applicant: PBA S.P.A., Tezze Sul Brenta (IT)

(72) Inventor: Francesca MASIERO, Bassano Del Grappa (IT)

(21) Appl. No.: 16/910,551

(22) Filed: Jun. 24, 2020

(30) Foreign Application Priority Data
Jun. 24, 2019 (IT) 102019000009867

(51) Int. Cl. E05B 55/00; E05B 63/00

(52) U.S. Cl. CPC E05B 55/005; E05B 15/04; E05B 63/006

(57) ABSTRACT

A door lock includes an outer enclosure constituted by a body that is substantially shaped like a flattened parallelepiped. The lock has a hole passing through the enclosure, with an axis of extension that is perpendicular to the base of the body, and is suitable for the insertion of a double handle unit. The lock further includes a spring latch exiting from a side wall of the body, through an opening, the spring latch being connected to the edge of the through hole and adapted to be actuated by the handle unit. The lock includes a seat for a cylinder, of the mortise type, the latter provided with an end cam and being accessible from the side of the enclosure that is adapted to correspond to the outside of the door, the cylinder being adapted to release the lock.

### CROSS-REFERENCE TO RELATED APPLICATIONS

This application is related to and claims the benefit of Italian Patent Application No. 102019000009867, filed on Jun. 24, 2019, the contents of which are herein incorporated by reference in their entirety.

### TECHNICAL FIELD

The present disclosure relates to a lock.

### BACKGROUND

Nowadays, several different types of lock exist.

Among these, there are:
cam locks,
mortise locks.

Cam locks are one-piece locks that are installed in a door inside a seat provided in the thickness of the door, and are partially fixed on the two opposite lateral surfaces of the door.

These locks comprise two large washers, one for each lateral surface of the door, between which is the mechanism for supporting the handles and, concentric with this mechanism, a cylinder that can be operated with a key, which is accessible from the side of the door presented to the outside of the building.

On the side of the door facing the inside of the building is the cam that controls the locking of the outside handle.

This cam is usually located in the neck of the handle.

By controlling the locking of the outside handle, the cam prevents the door from being opened without the key.

Such known art has some drawbacks.

First of all a cylinder is used which is not standard, but differs according to the maker.

This lack of standardization means it is difficult for cylinders to be interchangeable.

A locksmith therefore must have several different types of cylinder available, with consequent need for considerable warehouse space for its storage.

Furthermore, cam locks are usually quite large and have considerable encumbrances.

In addition, these locks lack versatility and it is therefore necessary to have at least two versions depending on whether the spring latch has to point to the right or to the left in the door.

Finally, cam locks cannot be applied to solid glass doors, without using adapted case for accommodation and support, because glass doors are not sufficiently thick to contain the internal part of these locks.

Mortise locks, on the other hand, are locks contained in a compact box which is accommodated in a door, within its thickness, in an adapted mortise.

The peculiarity of this type of lock is that it comprises a cylinder, called a “mortise cylinder”, which can be actuated with a key, and which has a cam, at its inside end, which is adapted to interact with a stop element of the spring latch, in order to lock or unlock the lock and, therefore, the door.

Usually these locks have a seat for a double handle unit which allows the two handles, the one inside the building and the one outside the building, to be mutually independent.

A double handle unit has two elongated portions, each one interacting with a respective handle, which can rotate independently of each other.

Such conventional techniques also have a number of drawbacks.

Mortise locks extend vertically with the cylinder arranged above the handles.

This results in a significant space occupation and the need for an adequate mortise in the door, which will present an equally significant space occupation.

Furthermore, the holes for the screws to affix the handles are not always horizontal, and this results in a lack of interchangeability of handles with standard European handles and return springs, in that, in the latter, the holes are horizontal.

In addition, such locks are not adapted to be installed on solid glass doors, even if suitable covers and supporting frames are used, owing to their considerable thickness.

What is more, they are expensive.

### SUMMARY

The aim of the present disclosure is to provide a lock that is capable of improving the known art in one or more of the above mentioned aspects.

Within this aim, the disclosure provides a lock that offers reduced encumbrances.

The disclosure also provides a lock in which a mortise cylinder is used.

The disclosure further provides a lock that is versatile and can be used without difficulty both in doors that have a spring latch operating to the right and in doors with a spring latch operating to the left.

The disclosure also provides a lock that is easier to be installed than comparable conventional locks.

The disclosure further provides a lock with which it is easy to lock the handle on the outside of the building.

The disclosure also provides a lock that can be easily used in solid glass doors, with covers and frames of reduced thickness.

The disclosure overcomes the drawbacks of the known art in an alternative manner to any existing solutions.

The disclosure further provides a lock that is highly reliable, easy to implement and of low cost.

This aim and these and other advantages which will become better apparent hereinafter are achieved by providing a door lock, comprising an outer enclosure which is constituted by a body that is substantially shaped like a flattened parallelepiped, wherein the lock comprises:
a hole which passes through said enclosure, with an axis of extension that is perpendicular to the base of said body substantially shaped like a flattened parallelepiped, and which is suitable for the insertion of a double handle unit,
a spring latch, which exits from a side wall of said body substantially shaped like a flattened parallelepiped of said enclosure, through an opening, said spring latch being connected to an edge of said through hole and being adapted to be actuated by the double handle unit,
a seat for a cylinder, of the mortise type, the latter being provided with an end cam and being accessible from a side of said enclosure that is adapted to correspond to an outside of said door, said cylinder being adapted to release said lock,
said through hole and said cylinder having an axis of extension that is parallel and lies on a same horizontal plane, in a configuration for use.

### BRIEF DESCRIPTION OF THE DRAWINGS

Further characteristics and advantages of the disclosure will become better apparent from the description of a preferred, but not exclusive, embodiment of the lock according to the disclosure, which is illustrated by way of non-limiting example in the accompanying drawings wherein:

FIG. 1 is a perspective view of a lock according to the disclosure, applied with cover and frames to a solid glass door;

FIGS. 1a and 1b are two different perspective views of a lock according to the disclosure;

FIG. 1c shows a detail that can be used in a lock according to the disclosure;

FIG. 2 is an internal view of the lock of FIGS. 1a and 1b;

FIG. 3 is an exploded view of the lock of FIGS. 1a and 1b;

FIG. 4 is an exploded view of the lock of FIGS. 1a and 1b, seen from the opposite side to FIG. 3.

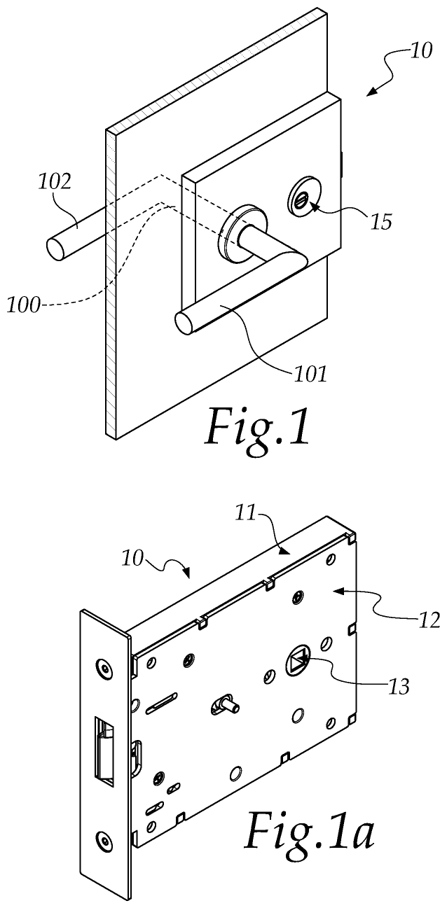

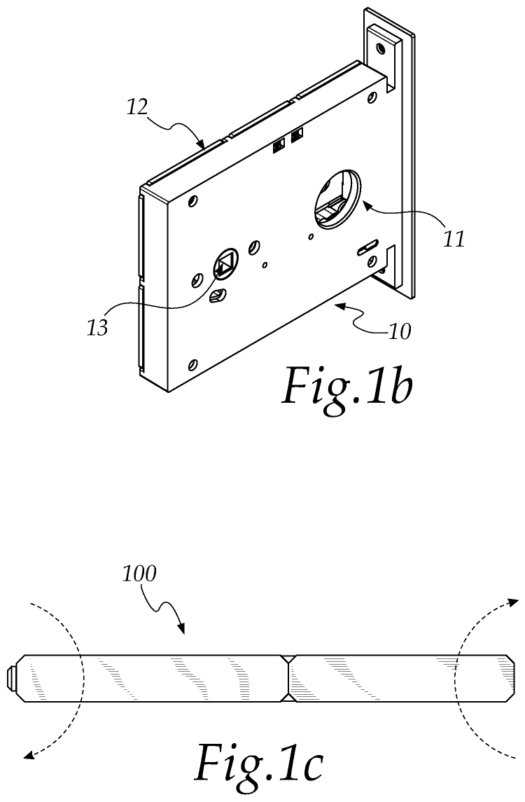

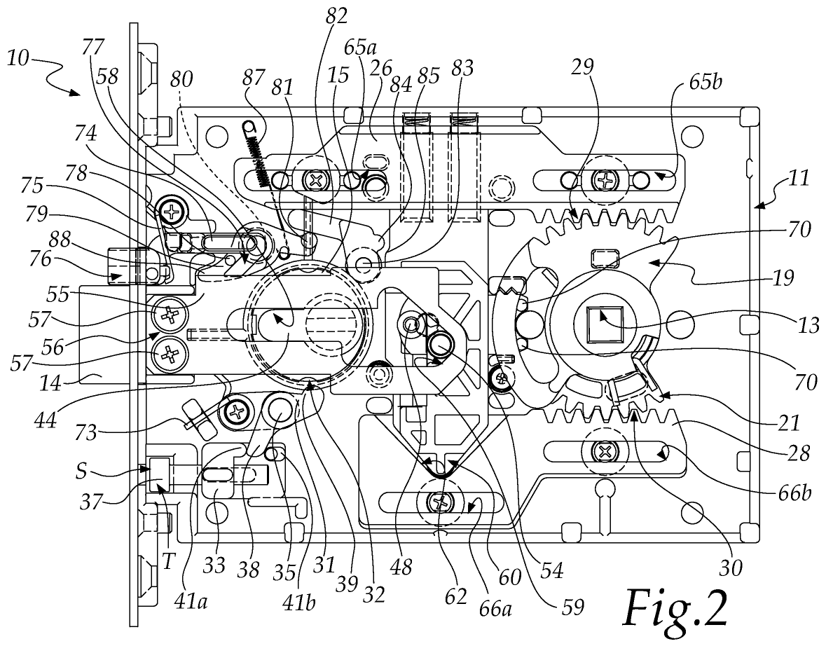

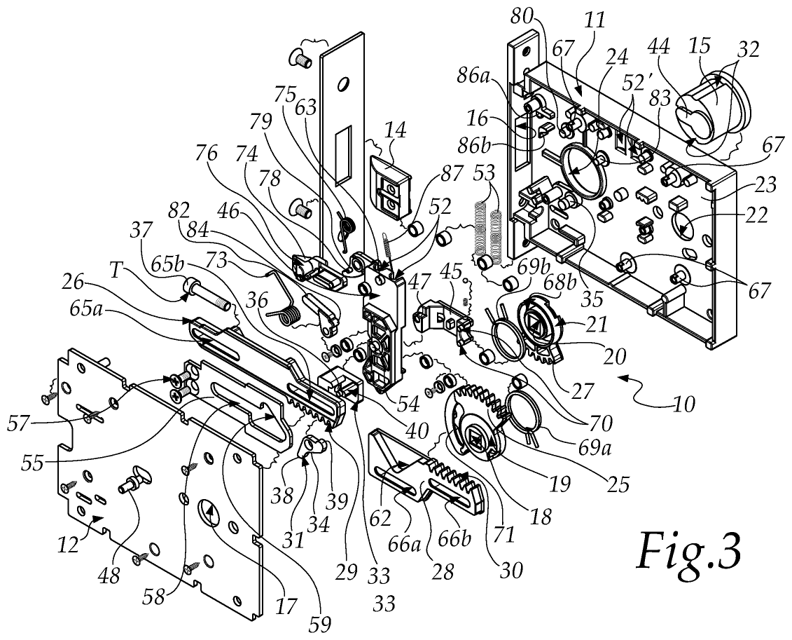

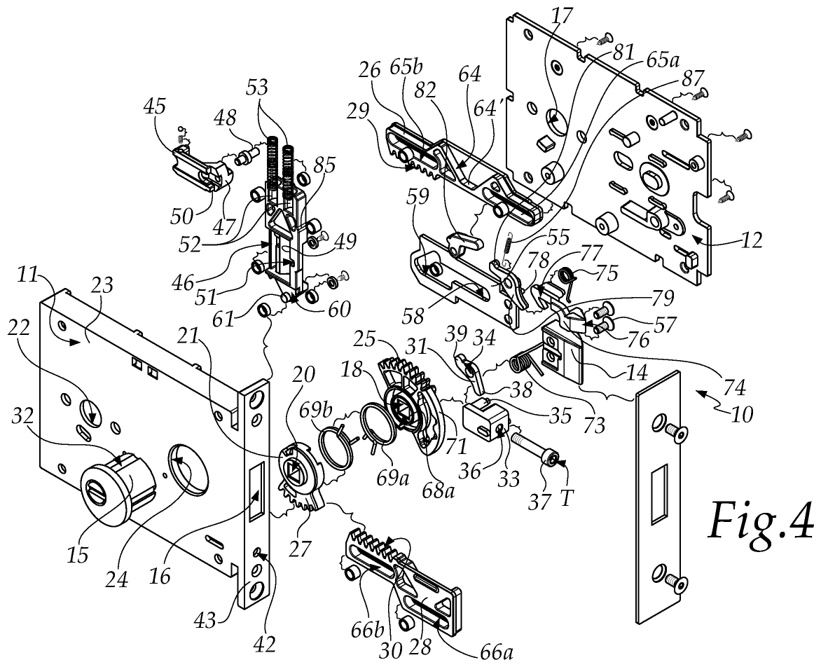

### DETAILED DESCRIPTION OF THE DRAWINGS

With reference to the figures, a door lock, according to the disclosure, is generally designated by the reference numeral 10.

The lock 10 is adapted to be accommodated in a suitable mortise in the thickness of a door, not shown in the figures, and comprises an outer enclosure which is constituted by a flattened parallelepiped. Such flattened parallelepiped comprises, for example, a substantially tray-like body 11 closed by a cover 12.

Such lock 10 has:
a hole 13 which passes through the enclosure with an axis of extension that is perpendicular to the cover 12, and which is adapted for the insertion of a double handle unit 100, the latter connected to the handles 101 and 102;
a spring latch 14, which exits from a side wall 43 of the tray-like body 11 of the enclosure, through an adapted opening 16, and which is connected to the edge of the through hole 13 and is adapted to be actuated by the handle unit;
a cylinder 15, of the mortise type, which is accessible from the side of the enclosure that is adapted to correspond to the outside of the door, such cylinder 15 being adapted to release the lock.

The expression “outside of the door”, in the present description, means the side of the door directed toward the outside of the room and/or of the building, when the door is in the closed position.

The expression “inside of the door”, in the present description, means the side of the door directed toward the inside of the room and/or of the building, when the door is in the closed position.

The use of a cylinder 15 of the mortise type makes it possible to use standard cylinders.

One of the peculiarities of the disclosure is that the spring latch 14 is reversible, and this makes it possible to invert its configuration, according to the application in which the lock is used and according to the hand to be used to open the door.

Another one of the peculiarities of the disclosure is that the through hole 13 and the cylinder 15 have an axis of extension that is parallel and lies on a same horizontal plane, in the configuration for use.

The expression “in a configuration for use”, in the present description, means that the lock 10 is installed in a door and is in an operative condition.

The through hole 13 passes through the enclosure, therefore through both the substantially tray-like body 11 and its cover 12, and has:
an edge having a circular profile, at the tray-like body 11 and at the cover 12,
an edge having a square profile, in the portion comprised between them.

Specifically, the through hole 13 is constituted in the following order by:
a first section 17, having a circular profile, which passes through the cover 12 of the enclosure,
a second section 18, having a square profile, which is provided on a first partially toothed wheel 19,
a third section 20, having a square profile, provided on a second partially toothed wheel 21,
a fourth section 22, having a circular profile, which passes through the base 23 of the substantially tray-like body 11.

The expression “partially toothed wheel” in the present description means a wheel that presents a plurality of teeth, but only on a limited portion of its profile.

The cylinder 15 is inserted into a threaded hole 24 on the base 23 of the substantially tray-like body 11.

In particular, the first wheel 19 and the second wheel 21 are coaxial.

The first wheel 19 has a toothed portion 25 in its upper part.

The terms “lower” and “upper” in the present description refer to the configuration for use of the lock 10.

This toothed portion 25 of the first wheel 19 is adapted to interact with a first partially rack-toothed element 26, in its rack 29.

The expression “partially rack-toothed element” in the present description means an element that presents a segment of rack, but only on a limited portion thereof.

The second wheel 21 has a toothed portion 27 in its lower part.

This toothed portion 27 of the second wheel 21 is adapted to interact with a second partially rack-toothed element 28, in its rack 30.

The cylinder 15, once inserted into the hole 24, is locked by way of a cylinder retainer 31, which is shaped so as to generate an interference with a groove 32 on the lateral surface of the cylinder 15.

The cylinder retainer 31 is connected to a movement element 33.

The cylinder retainer 31 has a through hole 34 adapted for the insertion of a pivot 35 that extends from the base of the body 11 and is able to rotate with respect to the latter.

The movement element 33 has a hole 36 for the partial insertion of a screw 37.

Such movement element 33 of the cylinder retainer 31 is shaped so as to have a portion 40 for interaction with the cylinder retainer 31 in its opposite end 38 from the end 39 that is to be inserted into the groove 32 of the cylinder 15.

In the example shown in the figure, the end 38 of the cylinder retainer 31 is arranged between two appendages 41a, 41b of the movement element 33.

Once the cylinder 15 is screwed into the hole 24, it is locked by way of the cylinder retainer 31.

As the screw 37 is unscrewed, it pushes the movement element 33, which in turn makes the cylinder retainer 31 rotate about the pivot 35, bringing its end 39 into a groove 32 of the cylinder 15, thus preventing the latter from being unscrewed and exiting from the hole 24.

The hole 36 of the movement element 33 corresponds to a first through hole 42 of the same side wall 43 of the body 11 from which the spring latch 14 protrudes.

The screw 37, the head T of which is captive in the seat S, can be screwed or unscrewed by way of a hexagonal key through the hole 42 which passes through the side wall 43 of the body 11. Such screw 37 is inserted into the hole 36 of the movement element 33.

The cylinder 15 interacts with its end cam 44 with a locking element 45 for locking a slider 46.

In particular, the cam 44 interacts with a first rounded end 47 of the locking element 45 for locking the slider 46.

Turning the key in the lock turns the cylinder 15 which, by way of its cam 44, moves the locking element 45 from the locked position to the unlocked position of the slider 46.

The locking element 45 passes through the slider 46 at an opening 49 of the latter. The slider 46 and the locking element 45 are adapted to move in mutually perpendicular directions and are shaped so as to have substantially the same thickness.

In particular, the slider 46 moves vertically while the locking element 45 moves horizontally.

The assembly constituted by the slider 46 and the locking element 45 has a substantially equal thickness to that of the slider 46 or of the locking element 45. In this manner the lock 10 is more compact than similar, conventional locks.

A first pivot 48 is fixed on the locking element 45 for locking the slider 46, proximate to and/or at the first end 47 thereof.

The first pivot 48 is accessible to the user from the inside of the door.

Such first pivot 48 serves to lock the lock and more specifically the handle on the outside, thus preventing the door from being opened from outside.

In order to lock the lock with the first pivot 48, this is moved in the direction of the spring latch 14.

Simultaneously the locking element 45 performs a translational motion, moving a protrusion 50 thereof that is adapted to be inserted into a corresponding recess 51 of the slider 46, thus obtaining an interference between the two that prevents the slider 46 from moving.

In particular the recess 51 of the slider 46 is arranged on the edge of its opening 49, closer to the spring latch 14, on the surface directed toward the base 23 of the body 11.

When the slider 46 is locked, the handle arranged on the outside of the door is also locked, as is better explained below.

The slider 46 has two grooves 52 in an upper portion thereof, on the surface directed toward the base 23 of the body 11, each groove for a first spring 53.

The base 23 of the body 11 has, in turn, at the grooves 52 of the slider 46, two grooves 52′, each one of which is adapted to define, with the corresponding groove 52, a seat for accommodating a respective first spring 53.

These first springs 53 are adapted to return the slider 46 to an inactive position, which corresponds to a configuration of the lock 10 in which the spring latch 14 protrudes from the body 11.

Such slider 46 has a first pivot 54 which extends from its surface that is directed toward the cover 12, perpendicularly thereto.

Such first pivot 54 is in a single piece with the slider 46 and is adapted to interact with an elongated plate 55 for supporting the spring latch 14.

The plate 55 has a first end 56 to which the spring latch 14 is fixed by way of two screws 57.

This plate 55 has an opening with an extension that is substantially parallel to its own, which is passed through both by the first pivot 48 of the locking element 45 and by the first pivot 54 of the slider 46.

The opening of the plate 55 is shaped so as to present a first, substantially linear portion 58, which is adapted to allow the sliding of the first pivot 48 of the locking element 45.

A second, widened portion 59 extends from this first portion 58 and is substantially shaped like a right-angled triangle, with one cathetus in the horizontal direction, the other cathetus in the vertical direction and the hypotenuse inclined and directed toward the through hole 13 and the first partially rack-toothed element 26.

The second portion 59 of the opening of the plate 55, and in particular the part corresponding to the hypotenuse, is adapted to interact with the first pivot 54 of the slider 46.

When the slider 46 rises, by virtue of the interaction between its first pivot 54 and the edge of the second portion 59 of the opening of the plate 55, the latter performs a translational motion toward the hole 13, retracting the spring latch 14.

The slider 46 has a V-shaped lower portion 60 from the apex of which extends a second pivot 61. In particular the second pivot 61 of the slider 46 extends in the direction of the body 11.

The second pivot 61 of the slider 46 is adapted to interact with and slide on a corresponding V-shaped contoured portion 62 of the second partially rack-toothed element 28.

The slider 46 has a third pivot 63 in the upper part, which extends on the side opposite to the side on which the second pivot 61 extends.

The third pivot 63 of the slider 46 is adapted to interact with and slide on a substantially V-shaped contoured portion 64 of the first partially rack-toothed element 26.

The contoured portion 64 has a horizontal portion 64′, for release, the function of which is explained below.

The first partially rack-toothed element 26 and the second partially rack-toothed element 28 each have two longitudinal guide openings, respectively:
first openings 65a and 65b, for the first partially rack-toothed element 26;
second openings 66a and 66b, for the second partially rack-toothed element 28.

Such longitudinal guide openings 65a-66b are adapted for the insertion of pivots 67 which extend from the base 23 of the substantially tray-like body 11 and which are adapted to keep the elements 26 and 28 horizontal in any configuration of the lock 10.

In particular, the substantially V-shaped contoured portion 64 of the first partially rack-toothed element 26 is comprised between the two first longitudinal guide openings 65a and 65b and one of these, 65b, is parallel to the rack 29 and has an extension substantially equal to it.

In the second partially rack-toothed element 28:
one second opening 66a is arranged below the V-shaped contoured portion 62 and has an extension that is substantially equal to the width of the latter;
the other second opening 66b is parallel to the rack 30 and has an extension that is substantially equal thereto.

The first partially toothed wheel 19 and the second partially toothed wheel 21 each have an annular seat 68a, 68b for the insertion of a second spring 69a, 69b.

Such second springs 69a, 69b are adapted to return the corresponding wheel 19, 21 to the inactive configuration, after the release of the handle.

The first partially toothed wheel 19 has an annular arc-like portion 71 which extends as a circular extension of the toothed portion 25.

The locking element 45 has two second pivots 70, which extend parallel to the first pivot 48 and starting from the same surface, but at the opposite end.

Such second pivots 70 are adapted to be inserted in and to interact with two corresponding recesses 72 of the annular arc-like portion 71, which are directed toward the hole 13.

In particular, when the second pivots 70 of the locking element 45 are inserted into the recesses 72 of the annular arc-like portion 71 of the first wheel 19, the locking element 45 can be driven directly by the handle on the inside of the door, without the need to intervene on its first pivot 48.

The spring latch 14 is connected to a third spring 73, adapted to return it to the inactive configuration, i.e. protruding from the body 11, after the removal of the stress on a handle, which is necessary to make it retract.

The structure 10 comprises an auxiliary spring latch 74, of the deadlatch type, adjacent to the spring latch 14 and above it.

The auxiliary spring latch 74 protrudes from the substantially tray-like body 11 through the same opening 16 from which the spring latch 14 protrudes, and is kept in this position by way of a fourth spring 75 to which it is connected.

Furthermore, the auxiliary spring latch 74 is comprised between two opposing guide ridges 86a, 86b, which extend from the base 23 of the body 11.

The purpose of this auxiliary spring latch 74 is to prevent a fraudulent attempt to make the spring latch 14 retract through the use of a thin tool, inserted into the fissure between the lock and the strike plate of the door, when the door is closed.

Such auxiliary spring latch 74 has a body with a substantially longitudinal extension, for the most part inside the body 11 of the structure 10.

The auxiliary spring latch 74 has a pointed first end 76 which is adapted to protrude from the body 11, and an elbow-shaped second end 77, opposite to the first end.

The second end 77 of the auxiliary spring latch 74 is adapted to interact with a first pivot 78 which is arranged substantially at a first end of a spring latch retainer 79.

Such first end of the spring latch retainer 79 is adapted to interact with the spring latch 14, in order to obstruct its movement.

The spring latch retainer 79 can rotate about a pivot 80 extending from the base 23 of the body 11 and has, at a second end, opposite to the first end, a second pivot 81 which is adapted to interact with a lever 82.

The spring latch retainer 79 is kept in contact with the lever 82 through the use of a fifth spring 87.

The lever 82 has a substantially L-shaped body with the short side hinged to a rotation pivot 83 and with the end of the long side adapted to interact with the spring latch retainer 79.

Such lever 82 has a shaping 84, proximate to the rotation pivot 83, that is adapted to interact with a corresponding step 85 of the slider 46.

In this manner, when the slider 46 rises, by virtue of the rotation of a handle, the step 85 of the slider 46 interacts with the shaping 84 of the lever 82, making the latter rotate about its pivot 83.

The lever 82 then lowers, interacting with the spring latch retainer 79, which rises, freeing the spring latch 14 to move.

The lock function of the spring latch 14 by the auxiliary spring latch 74, which interacts with the spring latch retainer 79, is active only when the door is closed and the auxiliary spring latch 74 is kept pressed by the interaction with the abutment of the door on the jamb.

When the door is closed, in fact, the auxiliary spring latch 74 is substantially completely inside the body 11: its first end 76 is retracted inside the body 11 and its second end 77 is not in contact with the pivot 78 of the spring latch retainer 79.

By virtue of the elastic return of the fifth spring 87, the spring latch retainer 79 rotates about its pivot 80, bringing its locking end 88 to interact with the spring latch 14, blocking the sliding thereof and keeping it, substantially, outside the body 11.

When the door is open, on the other hand, the locking end 88 of the spring latch retainer 79 does not interact with the spring latch 14, and the latter is free to move along all of its travel.

In this case, in fact, the first end of the auxiliary spring latch 74 is kept outside the body 11 by virtue of the elastic return of the fourth spring 75 and the second end 77 of the auxiliary spring latch 74 is in contact, and interacts, with the pivot 78 of the spring latch retainer 79.

The locking end 88 of the spring latch retainer 79 is raised and does not interact with the spring latch 14, allowing the latter to slide freely for all of its travel.

Operation of the lock 10, according to the disclosure, is as follows.

The partially toothed wheels 19 and 21 are driven by handles via a double handle unit, and mesh in the respective racks 29 and 30 of the partially rack-toothed elements 26 and 28, which are adapted to drive the slider 46.

In particular, by lowering the handle on the inside, the first wheel 19 rotates about the hole 13, meshing its toothed portion 25 on the rack 29 of the first partially rack-toothed element 26, which performs a translational motion in the opposite direction to that of the spring latch 14.

By virtue of the interaction between the third pivot 63 of the slider 46 and the corresponding substantially V-shaped contoured portion 64 of the first partially rack-toothed element 26, the slider 46 rises.

By virtue of the interaction between the first pivot 54 of the slider 46 and the edge of the second portion 59 of the opening of the plate 55, the plate 55 performs a translational motion, retracting the spring latch 14.

When the user releases the handle, this returns to the inactive position by way of the elastic return of the second spring 69a and the spring latch 14 returns to protrude from the body 11 by virtue of the elastic return of the third spring 73 and the slider 46 returns to its earlier position by virtue of the first springs 53.

If the handle on the outside is lowered, the second wheel 21 rotates about the hole 13, meshing its toothed portion 27 on the rack 30 of the second partially rack-toothed element 28, which performs a translational motion in the direction of the spring latch 14.

By virtue of the interaction between the second pivot 61 of the slider 46 and the corresponding V-shaped contoured portion 62 of the second partially rack-toothed element 28, the slider 46 rises.

By virtue of the interaction between the first pivot 54 of the slider 46 and the edge of the second portion 59 of the opening of the plate 55, the plate 55 performs a translational motion, retracting the spring latch 14.

When the user releases the handle, this returns to the inactive position by way of the elastic return of the second spring 69b and the spring latch returns to protrude from the body 11 by virtue of the elastic return of the third spring 73 and the slider 46 returns to its earlier position by virtue of the first springs 53.

The handles can rotate about their own axes in both directions; in this manner the lock is reversible and offers a versatility that similar conventional locks do not have.

In order to lock the lock, it is sufficient to make the first pivot 48 of the locking element 45 slide toward the spring latch 14. In this manner the protrusion 50 of the locking element 45 is inserted into the corresponding recess 51 of the slider 46, thus obtaining an interference between the two elements that prevents the slider 46 from moving.

Simultaneously, the two second pivots 70 of the locking element 45 are inserted into the recesses 72 of the annular arc-like portion 71 of the first wheel 19.

To unlock the lock from the inside, it is sufficient to turn the handle.

By virtue of its rotation, in fact, the first wheel 19 also rotates, and by virtue of the interaction between the recesses 72 of the latter and the two second pivots 70 of the locking element 45, these move in a direction opposite to that of the spring latch, thus releasing the slider 46.

The initial rotation of the first toothed wheel 19, which permits the translation of the locking element 45, is ensured by the horizontal portion 64′ of the contoured portion 64 of the first element 26 which makes it possible to delay the start of the raising of the slider 46.

To unlock the lock from the outside, on the other hand, the cylinder 15 is engaged.

Once the key is inserted and has been turned, the cam 44 of the cylinder 15 rotates and, by virtue of the interaction of this with the first end 47 of the locking element 45, the locking element moves in a direction opposite to that of the spring latch 14, thus releasing the slider 46.

When the locking element 45 is in the configuration of blocking the slider 46, the handle on the outside is also blocked, because the second partially rack-toothed element 28 is blocked and as a consequence the second wheel 21, connected to the outside handle, is also blocked.

In practice it has been found that the disclosure fully achieves the intended aim and objects by providing a lock that offers reduced encumbrances and in which a cylinder of standard type is used.

With the disclosure a lock has been devised that is versatile and which can be used without difficulty both in doors that have a spring latch operating to the right and in doors with a spring latch operating to the left.

In addition, with the disclosure a lock has been provided which can be installed more easily than similar, conventional locks and in which it is easy to lock the handle on the outside of the building.

Finally, with the disclosure a lock has been devised that, with a suitable frame and covering, can be used in solid glass doors, in that it has reduced encumbrances compared to the locks that are present on the market.

The disclosure thus conceived is susceptible of numerous modifications and variations, all of which are within the scope of the appended claims. Moreover, all the details may be substituted by other, technically equivalent elements.

In practice the materials employed, provided they are compatible with the specific use, and the contingent dimensions and shapes, may be any according to requirements and to the state of the art.

1. A door lock, comprising an outer enclosure which is constituted by a body that is substantially shaped like a flattened parallelepiped, wherein the lock comprises:
a hole which passes through said enclosure, with an axis of extension that is perpendicular to a base of said body substantially shaped like a flattened parallelepiped, and which is suitable for the insertion of a double handle unit,
a spring latch, which exits from a side wall of said body substantially shaped like a flattened parallelepiped of said enclosure, through an opening, said spring latch being connected to an edge of said through hole and being adapted to be actuated by the double handle unit, and
a seat for a cylinder, cylinder having an end cam and being accessible from a side of said enclosure that is adapted to correspond to an outside of said door, said cylinder being adapted to release said lock,
said through hole and said cylinder having an axis of extension that is parallel and lies on a same horizontal plane, in a configuration for use.

2. The lock according to claim 1, further comprising:
a first partially toothed wheel,
a second partially toothed wheel,
a first partially rack-toothed element, provided with a rack, and
a second partially rack-toothed element, provided with a rack,
said first partially toothed wheel and said second partially toothed wheel being coaxial.

3. The lock according to claim 1, wherein said through hole is constituted, in the following order, by:
a first section, having a circular profile, which passes through the wall of said body substantially shaped like a flattened parallelepiped that is opposite to said base,
a second section, having a square profile, which is defined on said first partially toothed wheel,
a third section, having a square profile, defined on said second partially toothed wheel, and
a fourth section, having a circular profile, which passes through the base of said body substantially shaped like a flattened parallelepiped.

4. The lock according to claim 2, wherein:
said first wheel has a toothed portion in an upper part, said toothed portion of said first wheel being adapted to interact with said first partially rack-toothed element in its rack,
said second wheel has a toothed portion in a lower part, said toothed portion of said second wheel being adapted to interact with said second partially rack-toothed element in its rack.

5. The lock according to claim 1, wherein said cylinder is locked by a cylinder retainer, said cylinder retainer being shaped so as to generate an interference with a groove disposed on the lateral surface of said cylinder, said cylinder retainer being connected to a movement element, said cylinder retainer having a through hole adapted for the insertion of a pivot that extends from said base of said body substantially shaped like a flattened parallelepiped and being able to rotate with respect to said pivot, said movement element having a hole for the at least partial insertion of a screw, said movement element for moving said cylinder retainer being shaped so as to have a portion for interaction with said cylinder retainer in an opposite end from the end that is to be inserted into said groove of said cylinder.

6. The lock according to claim 2, further comprising a slider and a locking element for locking said slider, said end cam of said cylinder interacting with a first rounded end of said locking element for locking said slider, said locking element passing through said slider at an opening of the latter, said slider and said locking element being adapted to move in mutually perpendicular directions and being shaped so as to have substantially the same thickness, said locking element having a protrusion thereof that is adapted to be inserted into a corresponding recess of said slider, thus obtaining an interference between the protrusion and the recess, said recess of said slider being arranged on the edge that is closest to said spring latch of said opening, said recess of said slider being arranged on the surface that is directed toward said base of said body substantially shaped like a flattened parallelepiped.

7. The lock according to claim 6, wherein a first pivot is fixed on said locking element configured for locking said slider, proximate to and/or at said first end thereof, said first pivot being accessible to the user from the inside of said door.

8. The lock according to claim 6, further comprising an elongated plate for supporting said spring latch, to which said spring latch is fixed.

9. The lock according to claim 8, wherein said slider has a first pivot which extends from its surface that is directed toward said wall of said body substantially shaped like a flattened parallelepiped which lies opposite to said base, at right angles thereto, said first pivot of said slider being adapted to interact with said plate.

10. The lock according to claim 9, wherein said plate has an opening with an extension that is substantially parallel to its own, said opening being passed through both by said first pivot of said locking element and by said first pivot of said slider, said plate being shaped so as to have:
a first, substantially linear portion, adapted to allow the sliding of said first pivot of said locking element, and
a second, widened portion, which extends from said first portion, said second portion being substantially shaped like a right-angled triangle, with one cathetus in the horizontal direction, the other cathetus in the vertical direction and the hypotenuse inclined and directed toward said through hole and said first partially rack-toothed element, said second portion of said opening of said plate being adapted to interact with said first pivot of said slider.

11. The lock according to claim 6, wherein said slider has:
a V-shaped lower portion, from a vertex of which a second pivot extends, said second pivot of said slider extending in a direction of said body substantially shaped like a flattened parallelepiped, said second pivot of said slider being adapted to interact and slide on a corresponding V-shaped contoured portion of said second partially rack-toothed element; and
a third pivot in the upper part, which extends from the side that is opposite to a side of extension of said second pivot, said third pivot of said slider being adapted to interact and slide on a substantially V-shaped contoured portion of said first partially rack-toothed element, said contoured portion of said first partially rack-toothed element having a horizontal portion.

12. The lock according to claim 2, wherein said first partially rack-toothed element and said second partially rack-toothed element each have two longitudinal guide openings, respectively:
first openings for said first partially rack-toothed element; and
second openings for said second partially rack-toothed element,
said longitudinal guide openings being adapted for the insertion of pivots which extend from said base of said body substantially shaped like a flattened parallelepiped, said substantially V-shaped contoured portion of said first partially rack-toothed element being comprised between said two first longitudinal guide openings, one of said two openings being parallel to said rack of said first partially rack-toothed element and having an extension that is substantially equal thereto, in said second partially rack-toothed element:
one of said second openings being arranged below said V-shaped contoured portion and having an extension that is substantially equal to the width of the latter, and
another one of said second openings being parallel to said rack of said second partially rack-toothed element and having an extension that is substantially equal thereto.

13. The lock according to claim 2, wherein said first partially toothed wheel and said second partially toothed wheel each have an annular seat for the insertion of a second spring.

14. The lock according to claim 6, wherein said first partially toothed wheel has an annular arc-like portion extending as a circular extension of said toothed portion.

15. The lock according to claim 14, wherein said locking element is provided with two second pivots, which extend parallel to said first pivot of said locking element and starting from the same surface, but at the opposite end, said second pivots being adapted to be inserted in and to interact with two corresponding recesses of said annular arc-like portion, said recesses being directed toward said hole.

16. The lock according to claim 1, further comprising an auxiliary spring latch disposed adjacent to and above said spring latch.

17. The lock according to claim 1, wherein said spring latch is reversible.
